(19) United States
(12) Patent Application Publication
(10) Pub. No.: US 2009/0115369 A1
(43) Pub. Date: May 7, 2009

(54) PORTABLE ELECTRONIC APPARATUS AND CIRCUIT AND METHOD FOR CHARGING RECHARGEABLE BATTERY THEREOF

(75) Inventors: Keng-Huan Lin, Taipei (TW); Yung-Tai Yang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: TRANSCEND INFORMATION , INC., Taipei (TW)

(21) Appl. No.: 11/962,122

(22) Filed: Dec. 21, 2007

(30) Foreign Application Priority Data
Nov. 7, 2007 (TW) 96142072

(51) Int. Cl. H02J 7/00; H01M 10/44

(52) U.S. Cl. 320/114; 320/160

(57) ABSTRACT

A portable electronic apparatus capable of dynamically adjusting a charging current includes a memory unit, a memory controlling unit, a detecting unit, a current-adjusting unit and a rechargeable battery. The memory controlling unit is coupled to the memory unit for reading/writing the data of the memory unit. The detecting unit is coupled to the memory controlling unit for detecting the portable electronic apparatus to determine whether or not the portable electronic apparatus executes any operation, for example, reading/writing data or playing music and thereby generating a detection result. The current-adjusting unit is coupled to the detecting unit for correspondingly adjusting the charging current according to the detection result. The rechargeable battery is coupled to the current-adjusting unit for receiving the charging current for charging.

### CROSS-REFERENCE TO RELATED APPLICATION

This application claims the priority benefit of Taiwan application serial no. 96142072, filed on Nov. 7, 2007. The entirety of the above-mentioned patent application is hereby incorporated by reference herein and made a part of this specification.

### BACKGROUND OF THE INVENTION

1. Field of the Invention

The present invention generally relates to a charging circuit and a charging method, and more particularly, to a portable electronic apparatus and a circuit and a method for charging the rechargeable battery thereof.

2. Description of Related Art

Along with the progress in science and technology, all kinds of electronic products are developed following the tendency of high speed, high efficiency and light-slim-short-small design. In the above-mentioned developing stream, all kinds of portable electronic apparatuses, such as portable multimedia player (PMP), MP3 player and digital photo frame, gradually dominate the developments and play a major role on the market. Usually a portable electronic apparatus is equipped a rechargeable battery to increase the usage and carry convenience and enhance the practicability thereof.

Since any operation of a portable electronic apparatus, such as reading/writing data, needs current to avoid a possible fault. Therefore, during charging a rechargeable battery of a portable electronic apparatus, the apparatus usually shares a portion of the current as a charging current, while the rest portion of the current is served for the portable electronic apparatus to execute any action at the time. However, a portable electronic apparatus does not keep in on-duty status all the time. Thus, once when a portable electronic apparatus is in off-duty status a larger portion of a charging current is used to charge the rechargeable battery, the net charging time can be effectively shortened.

### SUMMARY OF THE INVENTION

Accordingly, the present invention is directed to a portable electronic apparatus and a circuit and a method for charging the rechargeable battery thereof, so as to effectively speed the charging course and avoid a possible fault of operations during the charging course.

The present invention provides a portable electronic apparatus capable of dynamically adjusting the charging circuit. The apparatus includes a memory unit, a memory controlling unit, a detecting unit, a current-adjusting unit and a rechargeable battery, wherein the memory controlling unit is coupled to the memory unit for reading/writing the data of the memory unit; the detecting unit is coupled to the memory controlling unit for detecting whether or not the portable electronic apparatus executes an operation, following by generating a detection result; the current-adjusting unit is coupled to the detecting unit so as to correspondingly adjust the amount of the charging current according to the detection result; the rechargeable battery is coupled to the current-adjusting unit for receiving a charging circuit served to charge.

The present invention also provides a charging circuit of a rechargeable battery suitable for a portable electronic apparatus. The charging circuit includes a detecting unit and a current-adjusting unit, wherein the detecting unit is for detecting whether or not the portable electronic apparatus executes an operation and to thereby generate a detection result; the current-adjusting unit is coupled to the detecting unit so as to correspondingly adjust the amount of a received charging current to charge a rechargeable battery according to the detection result.

The present invention further provides a charging method of a rechargeable battery suitable for a portable electronic apparatus. The charging method includes following steps. When the portable electronic apparatus is receiving a charging current, whether or not the portable electronic apparatus executes an operation is detected. When it is found out the portable electronic apparatus does not execute any operation, i.e. in off-duty status, the charging circuit is adjusted to be a first current value to charge the rechargeable battery. When it is found the portable electronic apparatus executes an operation, i.e. in on-duty status, the charging circuit is adjusted to be a second current value to charge the rechargeable battery.

The present invention employs a detecting unit to detect whether or not the portable electronic apparatus executes any operation, for example, reading/writing data or playing music and uses the detection result as the base to adjust the charging current. When it is found the portable electronic apparatus is in off-duty status, the current-adjusting unit makes the charging current larger to enhance the charging efficiency of the rechargeable battery and speed the charging course. When it is found the portable electronic apparatus is in on-duty status, the current-adjusting unit makes the charging current smaller so as to avoid the portable electronic apparatus from malfunction due to insufficient current provided for executing an operation.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a portable electronic apparatus capable of dynamically adjusting the charging current according to the embodiment of the present invention.

FIG. 2 is a flowchart of a charging method of a rechargeable battery according to the embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

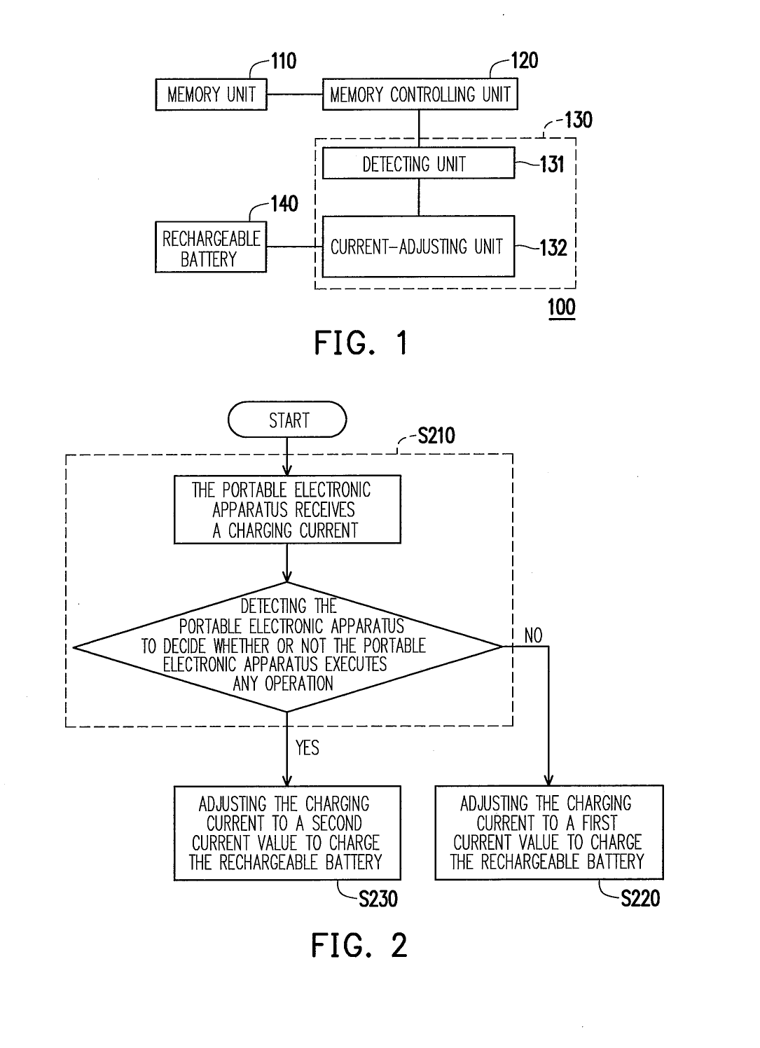

FIG. 1 is a diagram of a portable electronic apparatus capable of dynamically adjusting the charging current according to the embodiment of the present invention. Referring to FIG. 1, a portable electronic apparatus 100 provided by the present invention includes a memory unit 110, a memory controlling unit 120, a charging circuit 130 and a rechargeable battery 140, wherein the charging circuit 130 includes a detecting unit 131 and a current-adjusting unit 132 for adjusting the charging current in the portable electronic apparatus 100.

In the embodiment, the portable electronic apparatus 100 can be, but not limited to by the present invention, portable multimedia player (PMP), MP3 player or digital photo frame and so on. The memory unit 110 can be a non-volatile memory, for example, a flash memory, for storing the data required by a user. Besides, the rechargeable battery 140 can be nickel-metal hydride battery, solar battery or lithium battery.

Continuing to FIG. 1, the memory controlling unit 120 is coupled to the memory unit 110 for reading/writing the data thereof. the detecting unit 131 is coupled to the memory controlling unit 120 for detecting whether or not the portable electronic apparatus 100 executes an operation and thereby generating a detection result. In the embodiment, the above-mentioned operation of the portable electronic apparatus 100 is, but not limited to by the present invention, for example, reading/writing data from the memory unit 110 or playing music.

For example, when the detecting unit 131 finds out by detecting that the portable electronic apparatus 100 may not execute any operation, a first signal is generated, which is served as the base to indicate no operation is executed by the portable electronic apparatus 100. When the detecting unit 131 finds out the portable electronic apparatus 100 is executing an operation, a second signal is generated, which is served as the base to indicate the portable electronic apparatus 100 is executing an operation. The first signal and the second signal herein are the detection result generated by the detecting unit 131.

The current-adjusting unit 132 is coupled to the detecting unit 131 for correspondingly adjusting the amount of the charging current according to the detection result. For example, if the current-adjusting unit 132 receives the first signal, it means the portable electronic apparatus 100 does not execute any operation, thus, the current-adjusting unit 132 accordingly outputs a first current to charge the rechargeable battery 140.

In contrast, if the current-adjusting unit 132 receives the second signal, it means the portable electronic apparatus 100 is executing an operation, thus, the current-adjusting unit 132 accordingly outputs a second current to charge the rechargeable battery 140. In the embodiment, the first current value is greater than the second current value. In this way, the present invention is able to solidly speed the charging course resulting in a less charging time by adjusting the charging current, further avoid the portable electronic apparatus 100 from malfunction due to insufficient current provided for executing an operation.

In the following, another embodiment (not shown) is depicted to explain how the portable electronic apparatus 100 adjusts the charging current. First, it is assumed a computer system (not shown) is able to provide a current of about 500 mA through a connection interface (not shown), wherein the connection interface is, for example, a USB (universal serial bus) interface. When the portable electronic apparatus 100 is connected to the computer system through the connection interface for charging, the detecting unit 131 immediately detects the portable electronic apparatus 100. That is to say, the detecting unit 131 starts to detect the portable electronic apparatus 100 to determine whether or not an operation of reading/writing data is conducted.

If the detection result indicates the portable electronic apparatus 100 is reading data, the current-adjusting unit 132 would correspondingly outputs a current of about 250 mA to charge the rechargeable battery 140, while another current of about 250 mA is provided to the portable electronic apparatus 100 for reading data so as to avoid a possible malfunction of reading/writing data due to insufficient current.

In addition, if the detection result indicates the portable electronic apparatus 100 unlikely conducts reading/writing data, the current-adjusting unit 132 correspondingly outputs a current of about 400 mA (i.e. the current is increased from about 250 mA to about 400 mA) so as to speed the charging course of the rechargeable battery 140 resulting in a less charging time.

In the above-mentioned embodiment, the operation of the portable electronic apparatus 100 is exemplarily reading/writing data, based on which the charging current is adjusted. However, the present invention does not limit reading data. Any other operation of the portable electronic apparatus 100, for example, playing music, is also considered, and the charging current can be adjusted referring to the above description.

From the depiction of the above-mentioned embodiment, a charging method of a rechargeable battery can be extracted, as shown by FIG. 2. The charging method of the present invention is suitable for the above-mentioned portable electronic apparatus 100. Referring to FIG. 2, first in step S210, when a portable electronic apparatus receives a charging current, the portable electronic apparatus is detected whether or not an operation is conducted (for example, reading/writing data or playing music).

Next in step S220, when it is found the portable electronic apparatus does not execute any operation, the charging current is adjusted to be a first current value so as to charge a rechargeable battery. Then in step S230, when it is found the portable electronic apparatus is executing an operation, the charging current is adjusted to be a second current value to charge the rechargeable battery, wherein the first current value is greater than the second current value.

In summary the present invention employs a detecting unit to detect whether or not the portable electronic apparatus executes any operation, for example, reading/writing data or playing music and uses the detection result as the base to adjust the charging current. When it is found the portable electronic apparatus does not execute any operation, the current-adjusting unit makes the charging current larger to enhance the charging efficiency of the rechargeable battery and speed the charging course. When it is found the portable electronic apparatus execute an operation, the current-adjusting unit makes the charging circuit smaller so as to avoid the portable electronic apparatus from malfunction due to insufficient current provided for executing an operation. In short, the present invention is able to advance the charging efficiency to shorten the charging course and avoid a possible malfunction during a charging course.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A portable electronic apparatus capable of dynamically adjusting the charging current, comprising:
a memory unit;
a memory controlling unit, coupled to the memory unit for reading the data of the memory unit;
a detecting unit, coupled to the memory controlling unit for detecting whether or not the portable electronic apparatus executes an operation and thereby generating a detection result;
a current-adjusting unit, coupled to the detecting unit so as to correspondingly adjust the amount of the charging current according to the detection result; and
a rechargeable battery, coupled to the current-adjusting unit for receiving a charging circuit served to charge.

2. The portable electronic apparatus according to claim 1, wherein when the portable electronic apparatus does not execute any operation, the current-adjusting unit accordingly outputs a first current to charge the rechargeable battery; when the portable electronic apparatus executes an operation, the current-adjusting unit accordingly outputs a second current to charge the rechargeable battery, wherein the first current is greater than the second current.

3. The portable electronic apparatus according to claim 1, wherein the memory unit is a non-volatile memory.

4. The portable electronic apparatus according to claim 3, wherein the non-volatile memory is a flash memory.

5. The portable electronic apparatus according to claim 1, wherein the rechargeable battery is a nickel-metal hydride battery, a solar battery or a lithium battery.

6. The portable electronic apparatus according to claim 1, wherein the portable electronic apparatus is a portable multimedia player (PMP), an MP3 player or a digital photo frame.

7. A charging circuit of a rechargeable battery, suitable for a portable electronic apparatus; the charging circuit comprising:
a detecting unit for detecting whether or not the portable electronic apparatus executes an operation and thereby to generate a detection result; and
a current-adjusting unit, coupled to the detecting unit so as to correspondingly adjust the amount of a received charging current to charge the rechargeable battery according to the detection result.

8. The charging circuit according to claim 7, wherein when the current-adjusting unit does not execute any operation, the current-adjusting unit accordingly outputs a first current to charge the rechargeable battery; when the portable electronic apparatus executes an operation, the current-adjusting unit accordingly outputs a second current to charge the rechargeable battery, wherein the first current is greater than the second current.

9. The charging circuit according to claim 7, wherein the rechargeable battery is a nickel-metal hydride battery, a solar battery or a lithium battery.

10. The charging circuit according to claim 7, wherein the portable electronic apparatus is a portable multimedia player (PMP), an MP3 player or a digital photo frame.

11. A charging method of a rechargeable battery, suitable for a portable electronic apparatus; the charging method comprising:
when the portable electronic apparatus receives a charging current, the portable electronic apparatus is detected whether or not an operation is conducted;
when it is found by detecting the portable electronic apparatus does not execute any operation, the charging current is adjusted to be a first current value so as to charge the rechargeable battery; and
when it is found by detecting the portable electronic apparatus executes an operation, the charging current is adjusted to be a second current value to charge the rechargeable battery,
wherein the first current value is greater than the second current value.

12. The charging method according to claim 11, wherein the rechargeable battery is a nickel-metal hydride battery, a solar battery or a lithium battery.

13. The charging method according to claim 11, wherein the portable electronic apparatus is a portable multimedia player (PMP), an MP3 player or a digital photo frame.
